(19) United States
(12) Patent Application Publication
(10) Pub. No.: US 2025/0244251 A1
(43) Pub. Date: Jul. 31, 2025

(54) METHODS AND DEVICES FOR MONITORING MOISTURE LEVELS AND HUMIDITY CONTROL DEVICES

(71) Applicant: Boveda Inc., Minnetonka, MN (US)

(72) Inventors: John Thanh Ngoc Nguyen, Apple Valley, MN (US); Caden Peters, Minneapolis, MN (US)

(73) Assignee: Boveda Inc., Minnetonka, MN (US)

(21) Appl. No.: 19/036,563

(22) Filed: Jan. 24, 2025

Related U.S. Application Data
(60) Provisional application No. 63/625,352, filed on Jan. 26, 2024.

(51) Int. Cl. G01N 21/81; G01N 21/78; G01N 31/22

(52) U.S. Cl. CPC G01N 21/81; G01N 21/783; G01N 31/222

(57) ABSTRACT

The present disclosure generally relates to a humidity control indicator solution that is applied to a substrate to indicate a relative humidity. The humidity control indicator solution changes color depending on the relative humidity. The humidity control indicator solution may be non-toxic, such that it may be used in close proximity to items that cannot be near toxic substances, such as food items, or other consumables. In some embodiments, the substrate including the dried humidity control indicator solution may be applied to a product package, or a humidity control device.

### CROSS-REFERENCE TO RELATED APPLICATIONS

The present application claims the benefit of provisional application No. 63/625,352 filed Jan. 26, 2024, entitled, “Methods and Devices for Monitoring Moisture Levevels and Humidity Control Devices,” which is hereby incorporated herein by reference in its entirety.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many products and items benefit from a controlled humidity environment. In particular, many products and items benefit from an environment having a humidity content, such as a relative humidity, within a particular range or at a particular level. Some products and items can spoil, become damaged, become unusable, or lose freshness when subject to environments with too much or too little humidity. For example, tobacco products, such as cigars or loose tobacco, can benefit from an environment with a controlled humidity. Similarly, cannabis products, such as loose cannabis, pre-rolled cannabis products, or other products can benefit from an environment with a controlled humidity. Pharmaceutical or medicinal products can benefit from a controlled humidity environment. Food products may also benefit from such environments. Instruments, such as stringed instruments, can also benefit from such environments. Many other products and items may benefit from a controlled humidity as well.

Additionally, some products may require a particular humidity level or range in order to remain safe for consumers. For example, some products may need to be kept at or below a particular humidity level in order to ensure they are safe for consumption. In some cases, particular rules, regulations, or product standards or specifications may designate a safe or required humidity level or humidity range for products. For example, ASTM D8197 states storage for cannabis should be between 0.55-0.65 aW (55%-65% equivalent RH) to prevent mold and microorganism growth. As another example. Food Safety and Inspection Service (FSIS) has relative humidity level standards for food processing plants (for example coffee powder is 30-40%). FDA also has guidelines for optimal RH for testing labs (30-50%). To help maintain a desired or required humidity level or range for products, it may be desirable to control a humidity level within a product package or container in which such products or items are stored.

Humidity control devices may be used to effectively maintain humidity at or near a desired level, such as by absorbing and/or releasing humidity. Such devices are particularly useful in enclosed environments, such as inside of sealed packages or closed containers. However, many humidity control devices have a limited lifespan, after which the moisture absorbing and/or moisture releasing components of the device lose their effectiveness. It can be difficult to know when a humidity control device is no longer controlling humidity well and a user may continue to rely on a humidity control device which is no longer performing as expected. For example, users may rely upon feeling the humidity control device to detect a change which may indicate the humidity control device is no longer working at the desired level. However, relying on tactile sense is imprecise and users may continue to rely upon humidity control devices which are no longer functioning well, or may dispose of them too early when they are still functioning well.

Visual indicators exist for detecting humidity levels by a color change, such as humidity indicator cards (HICS). One type of indicator uses cobalt. For example, a blotting paper with cobalt (II) chloride base can be used as a humidity detector. However, cobalt is toxic. As such, it is inappropriate for many applications, and especially for consumable products.

Other humidity indicators have been developed that do not use cobalt, but their use is limited to particular humidity levels and do not work at the higher humidity levels required for some products, such as Relative Humidities of 60% or more.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended neither to identify key or critical elements of all embodiments, nor delineate the scope of any or all embodiments.

Embodiments of the present disclosure include a humidity control indicator solution comprising an aqueous solution of approximately 3-30 wt. % of a polymer and approximately 0.1-1.0 wt % of a dye. In some embodiments, the polymer and the dye are non-toxic. In some embodiments, the polymer is about 5.5 wt % of the solution, and the dye is about 0.5 wt % of the solution. The polymer can be polystyrene sulfonic acid (PPS). The dye can be brilliant blue. In other embodiments, the dye can be exberry vivid red.

Other embodiments of the present disclosure include a humidity control indicator, that includes a substrate; and a humidity indicator film on the substrate, wherein the humidity indicator film comprises a dried solution of an aqueous polymer and a dye. In some embodiments, the polymer and the dye are non-toxic. The polymer can be PSS. The dye can be brilliant blue. In some embodiments, the dried solution is dried at ambient temperature and humidity. In some embodiments, the dried solution is dried for at least eight hours. The substrate may comprise a humidity control device. In some embodiments, the substrate comprises a sheet. In some cases, the humidity control indicator further comprising an adhesive on a side of the film opposite the humidity indicator film.

Other embodiments of the present disclosure include a humidity control indicator system. The system includes, a humidity control device; and a humidity control indicator, comprising a substrate, and a humidity indicator film on the substrate, the humidity indicator film comprising a dried solution of PPS and brilliant blue, wherein the humidity control indicator is adhered to the humidity control device. In some embodiments, the dried solution may further comprise a thickener.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a photograph of a film of dried humidity indicator solution on polyethylene terephthalate at various humidity levels, according to some embodiments of the present disclosure;

FIG. 2 is a photograph of film of dried humidity indicator solution on various substrates at various humidity levels, according to some embodiments of the present disclosure;

FIG. 3 is a photograph of humidity indicator solution after drying at an increased temperature, according to some embodiments of the present disclosure;

FIG. 4 is a photograph of humidity indicator solution after air drying, according to some embodiments of the present disclosure; and

FIG. 5 is photographs of humidity indicator solution after air drying on various substrates, according to some embodiments of the present disclosure.

### DETAILED SUMMARY OF THE INVENTION

Various embodiments include humidity indicator systems which include a range of visible colors to indicate a given humidity level. The visible range of humidity sensitive colors may be provided by a humidity indicator solution including, in some embodiments, an organic acid compound (polymer) and organic dye which form a humidity indicating solution. For example, in some embodiments, the polymer may be polystyrene sulfonic acid and the dye may be brilliant blue (BB), also known as FD&C Blue 1.

The range of color of the indicator system may include a spectrum of colors that correspond to a range of humidities such that the same humidity indicator may be useful in a wide range of humidities. In some embodiments, the color change in response to humidity may be reversible and capable of repeated changes in color in response to humidity changes. That is, the color may change in response to an increase or decrease in humidity, and may return to a baseline color when the humidity returns to the original level. It may then change color again, in response to an increase or decrease in humidity. The correspondence between the color of the humidity indicator system and the humidity level may remain constant, even after repeated color changes. That is, the color correspondence to surrounding humidity may remain consistent even after repeated color changes in response to exposure to higher and/or lower humidities.

Various embodiments include a humidity indicator solution, alone or in combination with a support. In some embodiments, the humidity indicator solution may include a dye and a polymer. In some embodiments, the humidity indicator solution may include only nontoxic and/or organic components, making it useful with consumable products. For example, the humidity indicator solution may be free of cobalt. In some such embodiments, the color change solution may include an organic dye and a non-toxic polymer such as an organic acid compound.

The humidity indicator solution may be applied to a substrate, on which the solution is dried to create the humidity indicator system. The substrate may be any appropriate material. In some embodiments, the substrate may be a single sheet of material, such as but not limited to Polyethylene, PET, Polypropylene, or similar types of polymers. Metal substrates can also be used, for example, but not limited to steel. In some embodiments, the substrate may be multi-ply, containing two or more layers of material comprised of the same, or different materials. The humidity indicator system may be a card which may be placed and/or stored in any environment to determine a humidity level. In some such embodiments, the card may include an adhesive backing so that it may be applied to another item, such as a product package or a humidity control device. The substrate, and/or card may have any suitable dimensions that permits a person to easily see the elements on the card. In some embodiments, the substrate may be a component of a product package such as an outside or inside surface of the product package, such that the humidity indicator may provide information about the environment to which the product is exposed. In other embodiments, the substrate may be a component of a humidity control device, such that the humidity indicator system may provide information about the effectiveness of the humidity control device.

In some embodiments, the humidity indicator solution may be a solution such as an aqueous solution including a polymer and a dye and may optionally include other components. The polymer may be a non-toxic polymer and may be safe for human consumption, such as an organic acid polymer, for example. In some embodiments, the polymer may be a polystyrene, such as a polystyrene sulfonate such as polystyrene sulfonic acid (PSS), for example. The polystyrene sulfonic acid may be provided in the humidity control solution in the form of a salt, such as a calcium, sodium, or potassium salt. Advantageously, it is safe for human consumption, making it particularly useful for humidity indicators used with consumable products such as food, medication, cannabis, or tobacco products. The polymer such as polystyrene sulfonic acid may be between about 3 wt % and about 30 wt % of the solution. In some embodiments, the polymer such as polystyrene sulfonic acid may be present in the solution at between about 3 wt % and about 20 wt %, or between about 3 wt % and about 10 wt %, or between about 4 wt % and about 8 wt %. In some embodiments, the polymer may be present in the solution at between about 4 wt % and about 7 wt %, or between about 4.5 wt % and about 6.5 wt %, or between about 4 wt % and about 6 wt %, such as about 5 wt %, or about 5.5 wt %.

The dye which may be included in the humidity control solution may also be safe for human consumption and may be a non-toxic and/or organic dye. Examples of dyes which may be used in various embodiments include, but are not limited to brilliant blue, which may be provided in the humidity control solution as FD &C Blue 1, or a generic form of brilliant blue, or as brilliant blue powder, or as a dilution such as an aqueous dilution of brilliant blue powder, for example. Brilliant blue is particularly useful for the range of easily visible color change that extends over a broad range of humidity levels. Other dyes which may be used include green food coloring, exberry vivid red, and exberry brilliant pink. The choice of dye may depend upon the range of desired humidities of the environment in which the humidity indicator system will be used. For example, depending on the dye, the range of color change that may be detected by the naked eye may be narrower or wider. Certain dyes also only change color with a specific RH range, which may also be concentration dependent.

For example, Brilliant Blue best showed changes at 40-85% RH while neutral red was able to show changes from 10-45%. The dye may be present in the humidity indicator solution as between about 0.1 wt % and about 1.0 wt %, such as between about 0.1% wt % and about 0.7 wt %, or between about 0.1 wt % and about 0.5 wt %, such as about 0.1 wt %, or about 0.2 wt %, or about 0.3 wt %, or about 0.4 wt %, or about 0.5 wt %, or about 0.6 wt %.

The humidity indicator solution may include other components which may be useful such as for stabilizing the solution or thickening the humidity indicator solution to adjust the viscosity to assist with the application of the humidity control solution to the substrate. For example, the humidity indicator solution may include, but are not limited to, thickeners such as xanthan, natrosol, guar gum, or nonorganic thickeners such as clay, or silica, alone or in combination or with these or other thickeners. Alternatively, or additionally, the humidity indicator solution may include one or more rheology modifiers. Some examples would be xanthan gum, polyacrylates, clay, and silica. Such additives may generally be included about 0.1-2% by weight, in some embodiments. Other additives that may be but are not limited to surfactants like sulfates and sulfonates, for example, which may be added to the solution at the same levels as the rheology modifiers in some embodiments.

The humidity indicator solution may be prepared by mixing the desired amount of polymer such as PSS with water and with the dye, such as brilliant blue or a brilliant blue solution, and any other additive to form a homogeneous mixture.

The prepared humidity indicator solution may be applied to the substrate by applying the humidity indicator solution as one or more drops such as by a dropper or pipette, by pouring, spraying, painting, or other application method as appropriate for a liquid. Any other suitable method of application is also within the spirit of the present disclosure. After application, the humidity indicator solution may be left as is, or may be spread out into a thinner layer such as a line or other shape, with the solution evenly spread for a uniform color appearance. Once applied to the substrate and spread, if desired, the humidity indicator solution may be left to air dry under ambient conditions of room temperature and humidity. The humidity indicator is then ready to use to detect the humidity of a desired environment by placing the indicator into the desired environment, which results in the changing color of the solution on the substrate.

In some embodiments, the humidity indicator solution may be air dried on the substrate at ambient temperature and humidity, such as 68-77° F. and about 40% to about 50% relative humidity, such as about 45% relative humidity. In other embodiments, the humidity indicator solution may be dried more quickly, such as by using an oven or other heating mechanism, such as a dryer. However, air drying may produce superior results, producing an even and uniform humidity indicator film. In contrast, oven drying or other drying mechanism may result in a humidity indicator film that is less uniform, making a more visual assessment of the color more difficult.

In some embodiments, the color changes over a range of relative humidities from about 32% or less to about 84% or more, with distinct colors detectible throughout the range of relative humidities. For example, the dried humidity indicator solution may be yellow or amber-yellow at 32% RH, yellow-green at 45% RH, medium green at 62% RH, and dark green at 84% RH, such as humidity indicator solutions including brilliant blue and PSS.

The humidity indicator solution may be applied to and provided in dried form on a substrate. Substrates which may be used include, but are not limited to, paper and plastic of various types. In some embodiments, the substrate may be a thin sheet such as a paper or plastic sheet, such as a polyethylene terephthalate (PET), low density polyethylene (LDPE), or high density polyethylene (HDPE) films or sheets. The substrate may be the outer layer of a humidity control device, such as an outer layer of a Boveda humidity control device such as the outer film, or a polyethylene terephthalate (PET) sheet or sheet film.

In some embodiments, the substrate may be a water vapor permeable and water impermeable material such as, but not limited to, liquid high density polyethylene, microfibrous polyethylene, oriented polystyrene, polyvinylchloride, polyester, modified polyester, polystyrene, polytetrafluoroethylene, polyvinylidene chloride, polylactate, polyamides, polyurethane, ethylcellulose, cellulose acetate, polybutylene, polyethylene terephthalate, polyvinylchoride, nylon, polyvinylfluoride, polyethylenevinylacetate K-Resins, polyvinylalcohol, thin versions of low-density polyethylene, or polypropylene, TYVEK film (microfiberous polyethylene), microporous polyethylene, cellophane, polycarbonate, copolymers, laminates, rubbers, or combinations thereof. In some embodiments, the substrate may have a water vapor transmission rate (WVTR) of approximately about 5 to about 15 grams, such as about 10 grams, moisture per 100 square inches per 24 hours. The substrate may have any desired thickness as long as it may hold its shape with the solution applied.

In some embodiments, the humidity indicator solution is applied to and provided on a substrate such as a card, as a humidity indicator card. The humidity indicator card may be a small sheet which may be flexible, rigid or semirigid sheet of any shape. It may be provided along with a humidity control device, such as within the same outer humidity impermeable outer packaging as the humidity control device. In such cases, the humidity indicator card may be sized to have dimensions equal to or less than the humidity control device to fit easily in the same outer packaging as the humidity control device. In other embodiments, the humidity control card may be provided separately, such as individually or in a multipack including a plurality of cards, which may be provided in a humidity impermeable outer package.

The humidity indicator card may include a color comparison chart or scale printed on the card, which may be used as a reference key for the user to interpret the color of the humidity indicator film on the card. For example, the color comparison chart may include one or more colored portions such as spots of any shape, along with a printed indication of the relative humidity which corresponds to the printed color portions. The printed indication of the relative humidity, which may be numbers and or words, may be printed alongside the corresponding printed colored portions. The number and colors of the printed color portions may depend upon the particular humidity indicator solution which, in turn, may depend upon the desired humidity level in which it may be used.

In some embodiments, the humidity indicator card may include a visually perceptible color change over a range of humidity from about 32% to about 84% RH, such as humidity indicator cards including a humidity indicator solution including brilliant blue and PSS. In such embodiments, the indicator card may detect a wide range of humidity levels by a change in color of the humidity indicator film formed by the dried humidity indicator solution. As such, the color comparison chart may include a plurality of colors, such as yellow or amber-yellow, yellow-green, medium green, and dark green. The color comparison chart may include the corresponding humidity levels, which may be yellow or amber yellow at about 32% RH, yellow-green at about 45% RH, medium green at about 62% RH, and dark green at about 84% RH, though different colors and/or different humidity levels may alternatively be used, with the exact corresponding color for each humidity level provided on the chart. Alternatively, the card may also include additional colors and humidity levels between these levels, and or one or more of the humidity levels may be excluded. On the humidity indicator card, the color comparison chart may be in proximity to the humidity indicator film, so that an observer can easily see both the humidity indicator film and the printed colors of the color comparison chart together, for easy direct visual comparison, though in other embodiments, it may alternatively be printed elsewhere such as on a separate card or on packaging for the humidity indicator card.

The humidity indicator film including dried humidity indicator solution may be included with a humidity control device, such as on or within the humidity control device outer product layer. The humidity indicator film may provide information to a user about the condition of the humidity control device. For example, the visual indicator may indicate that the device has absorbed a maximum amount of water vapor or has released a maximum amount of water vapor and needs to be replaced, if it is no longer maintaining the desired humidity level.

In some embodiments, the humidity indicator film may be incorporated into or onto the outer layer of the humidity control product, such as the device pouch, through the normal package printing and assembly process. For example, the humidity control solution may be applied to the outer layer of the humidity control product and allowed to dry, either before, during, or after the outer layer is incorporated into the humidity control device. Alternatively, the humidity indicator solution may be applied to a different substrate and allowed to dry, and then that substrate may be applied to the outer layer of the humidity control product such as using adhesive on the opposite side of the substrate. In such embodiments, the humidity indicator solution may be applied to a substrate made of separate units, such as a dye cut sheet with an adhesive backing on a non-adhesive release sheet, such as a white or colorless paper sticker or other type of sticker. After the humidity indicator solution is applied to the sheet with the adhesive backing and is dried, the sheet unit may be peeled away from the release backing and then stuck to the outside surface of the humidity control product.

The humidity indicator system may be included with any appropriate humidity control device. Examples of humidity control devices with which the humidity indicator system may be used include, but are not limited to, the humidity control devices described in U.S. Pat. No. 10,081,465 entitled Container Assembly and Closure with Predetermined Humidity and Related Method, U.S. Pat. No. 11,358,778 entitled Moisture Control Devices, and U.S. Pat. Pub. No. 20230088606 entitled Enhanced Moisture Control Devices for the Preservation of Product in Closed Environments, the disclosures of which are all hereby incorporated by reference.

When the humidity indicator film is included on or in a humidity control device, the humidity control device may further include a color comparison chart, like that described above with regard to the humidity indicator card. As in the humidity indicator card, the color comparison chart may be in proximity to the humidity indicator film, so that an observer can easily see both the humidity indicator film and the printed colors of the color comparison chart together, for easy direct comparison, though it may alternatively be printed elsewhere.

The humidity indicator film, whether provided on a humidity control device or separately such as on a card, may be used to make a significant, perceptible change when the desired relative humidity is exceeded, for example, or alternatively when the relative humidity is too low relative to the desired humidity.

In some embodiments, the humidity indicator may be visible through a transparent window in the outer layer of the humidity control device, such as in the pouch or case of the device. The transparent window may be a clear and colorless plastic film, for example. In other embodiments, the humidity indicator may be applied to the outer layer of the humidity control device and may then be covered by the transparent window. Alternatively, the humidity indicator solution may be applied to an inner layer of the humidity control device, or to a substrate layer placed inside the humidity control device, and the outer layer of the humidity control device may include a transparent window aligned with the humidity control solution through which the color of the humidity control solution may be seen. In such embodiments, the humidity indicator may detect the humidity level inside of the humidity control device. In some embodiments, the humidity indicator solution may be applied directly to the outer layer of the humidity control device or the inner layer, or may be applied indirectly by adhering a separate sheet unit like a sticker as described above.

In one particular example, the humidity indicator solution may be an aqueous solution of 5.5 wt % polystyrene sulfonic acid (PSS) and 0.5 wt % brilliant blue, either alone or in combination with other components. The humidity indicator solution may be applied to the substrate of choice and air dried to form a humidity indicator film. This embodiment is particularly useful due to the broad range of humidities over which a color change is visible, the reversable nature of the color change allowing for repeated use, and the non-toxic and consumable nature of the components.

In use, the humidity indicator system, such as a card may be used with a humidity control device in an enclosed environment such as an airtight environment or space or package or any environment or space in which humidity control is desired. A user may place the humidity indicator in the humidity-controlled space, along with a humidity control device selected for the desired controlled level of humidity. The humidity indicator system may be a part of the humidity control device or may be physically separate. Later, such as the next day, week, or month, the user may check the humidity of the humidity-controlled space by observing the color of the humidity indicator film and comparing the observed color to the color chart. If the color of the humidity indicator solution corresponds to the desired humidity, the user is assured that the humidity control device is working as desired. The user can then recheck the color of the humidity indicator solution at a later time (such as days, weeks, or months later), to again confirm that the humidity-controlled space remains at the desired humidity level. The user can repeat this process until the color of the humidity indicator solution indicates a humidity that is higher or lower than the desired humidity. The user then knows that the humidity control device is no longer functioning properly and has reached the end of its useful life. The user can then replace the humidity control device with a new humidity control device in the humidity-controlled space.

If the humidity indicator was a component of the original humidity control device, the user may replace the humidity indicator system (again as a component of the humidity control device or as a separate item). However, if the humidity indicator was separate from the original humidity control device, the user can leave the humidity indicator in the humidity-controlled environment and continue to use it for monitoring the humidity control achieved by the replacement humidity control device. This is because the color changes of the humidity indicator solution are reversable, so the humidity indicator can be used to monitor humidity levels and changes in humidity levels repeatedly.

The humidity indicator system allows users to visually monitor the effectiveness of the humidity control device. In this way, they can more accurately assess whether or not the humidity control device continues to function as desired or needs to be replaced, instead of estimating the lifespans and replacing it too early (creating an unnecessary cost) or too late (resulting in reduced humidity control). By using a humidity indicator system, it is also less likely that the user will continue to use a humidity control device beyond its expiration, since the expiration is easy to detect.

The humidity indicator system may be used to detect humidity levels for the enhanced preservation of consumable items such as tobacco, and cannabis as well as other consumable and non-consumable items which are subject to degradation such as wood items like instruments, works of art, artifacts, cabinets, such as gun cabinets, guns, and collectible products including paper-based products such as sports memorabilia cards like baseball cards. Among food items with which various embodiments may be used include, but are not limited to, coffee, tea, fruits, vegetables, and candy such as gummy candies. They may also be used in humidity-controlled environments to ensure the correct humidity to maintain a freshness or other attribute of fresh food, such as crispiness, crunchiness, softness, etc., such as for as for nuts, or vegetables, marshmallows, etc. Various embodiments may be used with cannabis, hemp and cannabis and hemp products.

The humidity indicator may be incorporated into or onto a humidity control device. For example, the humidity indicator may be adhered to a surface of the humidity control device, or the humidity indicator solution may be applied directly to the humidity control device such that the surface of the humidity control device may be both a component of the humidity control device and the substrate of the humidity indicator solution. In some embodiments, the humidity indicator system or humidity indicator solution may be applied to the humidity control device polymeric pouch or packet, which may be a flexible film container having folded or sealed outer edges, for example, having walls sufficiently permeable to permit migration of water through the film in the form of water vapor and yet thick enough to prevent the escape of liquid water, containing a solution including an organic or an inorganic solute (e.g., salt or sugar) and water and other optional components, such as, but not limited to vegetable gum. The humidity indicator system or the humidity indicator film may be applied to a base layer and/or a top layer of the humidity control device, for example, which may be moisture permeable and liquid impermeable. In some embodiments, the humidity control device may optionally include a case with a plurality of openings, and the humidity indicator system or the humidity indicator solution may be applied to the case. The case may be a material such as a polymer, metal, glass, ceramic, wood, netting, or felt-like material such as paper, cloths, fur felt, plastic fibers, for example.

### EXAMPLES

Various dyes were used in the following examples. The green food coloring was McCormick Culinary Green Food Coloring.

### Example 1

Aqueous solutions were prepared by diluting a polymer and a dye in 20 g water. Two different concentrations of polymer were used. In each case, the polymer was either PSS or PEI, at 0.1 g or 5 g. The dye was either methylene blue or neutral red at 0.03 g. The color of the solutions immediately after mixing is shown in Table 1, below.

TABLE 1

| Polymer | 0.1 g PSS | 5 g PSS | 0.1 g PEI | 5 g PEI |
|---|---|---|---|---|
| methylene | dark blue | green/blue | dark blue | light blue |
| blue | | | | |
| neutral red | dark red | pinkish | orange | light yellow |

Immediately after mixing, about 2-3 drops (approximately 0.1 ml) of each solution, the solution was applied to a separate piece of paper or PET film. The papers and films were left to air dry at room temperature and ambient humidity for at least 8 hours.

After drying, the papers with the solutions were placed in controlled humidity environments at either low humidity (10-15% RH), ambient humidity (45% RH), high humidity (62%) or very high humidity (84% RH). The films were placed in a controlled humidity environment at ambient humidity. The initial color of the solution was observed immediately after mixing and the color of the dried solution on the paper and on the film was observed after 5 days and after 6 days, at which point the experiment was completed.

Tables 2-9 show the results at day 5 and day 6 at each humidity level. Table 2 shows the results for 0.1 g PSS and methylene blue. Table 3 shows the results for 5 g PSS and methylene blue. Table 4 shows the results for 0.1 g PEI and methylene blue. Table 5 shows the results for 5 g PEI and methylene blue. Table 6 shows the results for 0.1 g PSS and neutral red. Table 7 shows the results for 5 g PSS and neutral red. Table 8 shows the results for 0.1 g PEI and neutral red. Table 9 shows the results for 5 g PEI and neutral red.

TABLE 2

| 0.1 g | | | | | |
|---|---|---|---|---|---|
| PSS MB | 10-15% | Ambient | Ambient | 62% RH | 84% RH |
| (dark blue) | RH paper | paper | film | paper | paper |
| Day 5 | dark green | dark blue | dark blue | dark blue | dark green |
| Day 6 | dark blue | dark blue | dark green | dark blue | dark blue |

TABLE 3

| 5 g PSS MB | 10-15% | Ambient | Ambient | 62% RH | 84% RH |
|---|---|---|---|---|---|
| (green blue) | RH paper | paper | film | paper | paper |
| Day 5 | light green | light green | dark green | greenish | green |
| Day 6 | blue | blue | green | green | green |

TABLE 4

| 0.1 g | | | | | |
|---|---|---|---|---|---|
| PEI MB | 10-15% | Ambient | Ambient | 62% RH | 84% RH |
| (dark blue) | RH paper | paper | film | paper | paper |
| Day 5 | dark blue | dark green | dark blue | dark blue | dark green |
| Day 6 | dark blue | dark blue | dark blue | dark blue | dark blue |

TABLE 5

| 5 g PEI MB | 10-15% | Ambient | Ambient | 62% RH | 84% RH |
|---|---|---|---|---|---|
| (light blue) | RH paper | paper | film | paper | paper |
| Day 5 | light blue | dark blue | dark blue | blue | blue |
| Day 6 | blue | blue | blue | blue | blue |

TABLE 6

| 0.1 g | | | | | |
|---|---|---|---|---|---|
| PSS NR | 10-15% | Ambient | Ambient | 62% RH | 84% RH |
| (dark red) | RH paper | paper | film | paper | paper |
| Day 5 | dark green | dark blue | dark blue | dark blue | dark blue |
| Day 6 | dark blue | dark blue | dark blue | dark blue | dark blue |

TABLE 7

| 5 g PSS NR | 10-15% | Ambient | Ambient | 62% RH | 84% RH |
|---|---|---|---|---|---|
| (pinkish) | RH paper | paper | film | paper | paper |
| Day 5 | yellow/ | light blue | dark blue | lighter | purple/ |
| | green | | | blue | blue |
| Day 6 | yellow/ | blue | blue | blue | purple |
| | green | | | | |

TABLE 8

| 0.1 g | | | | | |
|---|---|---|---|---|---|
| PEI NR | 10-15% | Ambient | Ambient | 62% RH | 84% RH |
| (orange) | RH paper | paper | film | paper | paper |
| Day 5 | red/orange | orange | orange | orange | orange/red |
| Day 6 | orange/red | orange | orange | orange | orange |

TABLE 9

| 5 g | | | | | |
|---|---|---|---|---|---|
| PEI NR | | | | | |
| (light | 10-15% | Ambient | Ambient | 62% RH | 84% RH |
| yellow) | RH paper | paper | film | paper | paper |
| Day 5 | yellow | yellow | brown/ | yellow | yellow |
| | | | orange | | |
| Day 6 | yellow | yellow | brown/ | yellow | yellow |
| | | | orange | | |

### Example 2

As in Example 1, aqueous solutions were prepared by diluting a polymer and a dye in 20 g water, and the polymer was either PSS or PEI, at 0.1 g or 5 g. The dye was 0.3 g of either brilliant blue (BB) or green food coloring (GFC).

As in example 1, immediately after mixing, 2-3 drops (about 0.1 ml or 0.1 g) of each solution was applied to a separate piece of paper and dried at room temperature. The color of the solution on the paper is shown in Table 1, below, which shows the color after application to the substrate and after drying. Samples were also applied to a PET film.

TABLE 10

| Polymer | 0.1 g PSS | 5 g PSS | 0.1 g PEI | 5 g PEI |
|---|---|---|---|---|
| brilliant blue | denim blue | teal | navy blue | cerulean blue |
| green food | light green | clear/yellowish | green | clear/yellowish |
| coloring | | | | |

The papers with the films of the solutions were placed in controlled humidity environments at either low humidity (10-15% RH), ambient humidity (45% RH), high humidity (62%) or very high humidity (84% RH). The films were placed in a controlled humidity environment at ambient humidity. The color of the solution on the paper and on the film was observed after 1 day and after 6 days.

The papers and films, including solutions made with PSS, were then placed into new humidity environments to reverse the humidity changes. The low and ambient humidity papers and films were placed in a controlled 84% humidity environment and the 62% and 84% papers were placed in a low humidity environment. The color of the solution on the paper and the film was observed after 1 day (day 7) and 2 days (day 8) in the reversed humidity environment.

Tables 11-18 show the results at days 1 and 6, as well 7 and 8 for the solutions including PSS, at each humidity level. Table 11 shows the results for 0.1 g PSS and brilliant blue. Table 12 shows the results for 5 g PSS and brilliant blue. Table 13 shows the results for 0.1 g PEI and brilliant blue. Table 14 shows the results for 5 g PEI and brilliant blue. Table 15 shows the results for 0.1 g PSS and green food coloring. Table 16 shows the results for 5 g PSS and green food coloring. Table 17 shows the results for 0.1 g PEI and green food coloring. Table 18 shows the results for 5 g PEI and green food coloring.

TABLE 11

| 0.1 g PSS BB | 10-15% | Ambient | Ambient | 62% RH | 84% RH |
|---|---|---|---|---|---|
| (denim blue) | RH paper | paper | film | paper | paper |
| Day 1 | goldenrod yellow | denim blue | dark green | pickle green | dark green |
| Day 6 | gold yellow | muddy green | muddy green | muddy green | dark green |
| | 84% RH (humidity reversed) | | | 10-15% RH (humidity reversed) | |
| Day 7 | dark green | green | dark green | gold yellow | gold yellow |
| Day 8 | dark green | green | dark green | gold yellow | gold yellow |

TABLE 12

| 5 g | | | | | |
|---|---|---|---|---|---|
| PSS BB | 10-15% | Ambient | Ambient | 62% RH | 84% RH |
| (teal) | RH paper | paper | film | paper | paper |
| Day 1 | paler | ocean | light green | olive/ | light green |
| | yellow | blue/teal | | yellow | |
| Day 6 | pale | yellow | yellow | yellow | green |
| | yellow | | | | |
| | 84% RH - humidity reversed | | | 10-15% RH - humidity reversed | |
| Day 7 | green | light green | green | yellow | yellow |
| Day 8 | green | light green | green | yellow | yellow |

TABLE 13

| 0.1 g | | | | | |
|---|---|---|---|---|---|
| PEI BB | 10-15% | Ambient | Ambient | 62% RH | 84% RH |
| (navy blue) | RH paper | paper | film | paper | paper |
| Day 1 | clear/ | navy blue | navy blue | navy blue | navy blue |
| | colorless | | | | |
| Day 6 | colorless | navy blue | blue | blue | dark blue |

TABLE 14

| 5 g | | | | | |
|---|---|---|---|---|---|
| PEI BB | | | | | |
| (cerulean | 10-15% | Ambient | Ambient | 62% RH | 84% RH |
| blue) | RH paper | paper | film | paper | paper |
| Day 1 | colorless | teal blue | teal-ish blue | teal blue | teal blue |
| Day 6 | colorless | light blue | greenish | light blue | teal |

TABLE 15

| 0.1 g | | | | | |
|---|---|---|---|---|---|
| PSS GFC | 10-15% | Ambient | Ambient | 62% RH | 84% RH |
| (light green) | RH paper | paper | film | paper | paper |
| Day 1 | paler yellow | light green | yellow | yellow | light green |
| Day 6 | pale yellow | yellow | yellow | yellow | light green |
| | 84% RH (humidity reversed) | | | 10-15% RH (humidity reversed) | |
| Day 7 | light green | light green | light green | yellow | yellow |
| Day 8 | light green | light green | light green | yellow | yellow |

TABLE 16

| 5 g | | | | | |
|---|---|---|---|---|---|
| PSS GFC | | | | | |
| (clear/ | 10-15% | Ambient | Ambient | 62% RH | 84% RH |
| yellowish) | RH paper | paper | film | paper | paper |
| Day 1 | clear | clear/yellow | clearer yellow | colorless | colorless |
| | yellow | | | yellow | yellow |
| Day 6 | clear | clear/yellow | clear yellow | clear yellow | colorless |
| | yellow | | | | yellow |

| Humidity | 84% RH | 84% RH | 84% RH | 10-15% | 10-15% |
|---|---|---|---|---|---|
| reversed | paper | paper | film | RH paper | RH paper |
| Day 7 | yellow | clear/yellow | clear yellow | clear yellow | clear yellow |
| Day 8 | yellow | clear/yellow | clear yellow | clear yellow | clear yellow |

TABLE 17

| 0.1 g | | | | | |
|---|---|---|---|---|---|
| PEI GFC | 10-15% | Ambient | Ambient | 62% RH | 84% RH |
| (green) | RH paper | paper | film | paper | paper |
| Day 1 | very light | light green | light green | light green | light green |
| | yellow | | | | |
| Day 6 | clear | light green | light green | yellow green | light green |
| | yellow | | | | |

TABLE 18

| 5 g | | | | | |
|---|---|---|---|---|---|
| PEI GFC | | | | | |
| (clear/ | 10-15% | Ambient | Ambient | 62% RH | 84% RH |
| yellowish) | RH paper | paper | film | paper | paper |
| Day 1 | colorless | colorless | darker | colorless | colorless |
| | | | yellow | | |
| Day 6 | colorless | colorless | colorless | yellow | colorless |
| | | | | | yellow |

### Example 3

As in Examples 1 and 2, aqueous solutions were prepared by diluting 0.1 g or 5 g of PSS or PEI and a dye in 20 g water. In this example, the dye was 0.3 g of either Exberry Vivid Red (VR) or Exberry Brilliant Pink (BP).

As in Examples 1 and 2, immediately after mixing, 2-3 drops (0.1 ml or 0.1 g) of each solution, the solution was applied to a separate piece of paper and dried at room temperature. The initial colors were assessed immediately after mixing. Samples were also applied to a PET film.

The papers with the films of dried solutions were placed in controlled humidity environments at either low humidity (10-15% RH), ambient humidity (45% RH), high humidity (62%) or very high humidity (84% RH). The films were placed in a controlled humidity environment at ambient humidity. The color of the solution on the paper and on the film was observed after 5 days and then the experiment was discontinued.

Table 19 shows the results for each substrate at day 0 (immediately after mixing) and day 5.

TABLE 19

| Solution | Day 5 | | | | |
|---|---|---|---|---|---|
| (color | 10-15% | Ambient | Ambient | 62% RH | 84% RH |
| day 0) | RH paper | paper | film | paper | paper |
| 0.1 g | dark red | red | deep red | red | red |
| PSS VR | | | | | |
| (red) | | | | | |
| 5 g | orange-ish | clear | clear | clear | clear |
| PSS VR | | orange | orange | orange | orange |
| (clear) | | | | | |
| 0.1 g | colorless/ | colorless | colorless | colorless | colorless |
| PEI VR | yellow | | yellow | | |
| (muddy | | | | | |
| green) | | | | | |
| 5 g | colorless | colorless | colorless | colorless | colorless |
| PEI VR | | | | | |
| (clear) | | | | | |
| 0.1 g | red/orange | red | deep red | red | red |
| PSS BP | | | | | |
| (red) | | | | | |
| 5 g | orange-ish | light | clear | clear | clear |
| PSS BP | | red/orange | orange | orange | orange |
| (light | | | | | |
| pink/red) | | | | | |
| 0.1 g | colorless | colorless | colorless | colorless | colorless |
| PEI BP | yellow | yellow | yellow | | |
| (light | | | | | |
| green) | | | | | |
| 5 g | colorless | colorless | colorless | colorless | colorless |
| PEI BP | | | | | |
| (colorless) | | | | | |

### Example 4

Two different amounts of PSS (0.09 g and 0.9 g) were added to 20 g of water and 0.09 g of a dye (NR, green food coloring, or brilliant blue). A sample of each solution was applied separately to pieces of paper and allowed to dry at room temperature. The papers were placed in humidity control environments as in Examples 1-3. The color of the solutions immediately after mixing and 1 hour after application to the papers is shown in table 20, below.

TABLE 20

| | 0.09 g PSS | 0.9 g PSS |
|---|---|---|
| NR | dark red - immediate | Red - immediate |
| | dark blue - after 1 hour | Purple/red - after 1 hour |
| green food | green | light green |
| coloring | | |
| Brilliant blue | dark blue | blue |

The colors of the films of dried solutions on the paper in each humidity-controlled environment was assessed at days 1 and 2. The results are shown in tables 21-26, below.

TABLE 21

| 0.09 g | | | | | |
|---|---|---|---|---|---|
| PSS NR | 10-15% | Ambient | Ambient | 62% RH | 84% RH |
| (dark red) | RH paper | paper | film | paper | paper |
| Day 1 | dark blue | deep red | dark red | dark blue/red | dark red |
| | (purple) | | | | |
| Day 2 | dark blue | deep red | deep red | dark blue | dark red |
| 0.09 g | | | | | |
| PSS NR | 10-15% | Ambient | Ambient | 62% RH | 84% RH |
| (dark red) | RH paper | paper | film | paper | paper |
| Day 1 | dark blue | deep red | dark red | dark blue/red | dark red |
| | (purple) | | | | |
| Day 2 | dark blue | deep red | deep red | dark blue | dark red |

TABLE 22

| 0.9 g | | | | | |
|---|---|---|---|---|---|
| PSS NR | 10-15% | Ambient | Ambient | 62% RH | 84% RH |
| (red) | RH paper | paper | film | paper | paper |
| Day 1 | dark blue | purple/red | dark purple | dark blue | purple |
| Day 2 | blue | purple/red | purple/red | purple | purple |

TABLE 23

| 0.09 g | | | | | |
|---|---|---|---|---|---|
| PSS GFC | 10-15% | Ambient | Ambient | 62% RH | 84% RH |
| (green) | RH paper | paper | film | paper | paper |
| Day 1 | yellow | light green | light green | yellow | light green |
| Day 2 | yellow | light green | light green | yellow | light green |

TABLE 24

| 0.9 g | | | | | |
|---|---|---|---|---|---|
| PSS GFC | 10-15% | Ambient | Ambient | 62% RH | 84% RH |
| (light green) | RH paper | paper | film | paper | paper |
| Day 1 | clear | yellow | clear | yellow | yellow |
| | yellow | green | yellow | green | green |
| Day 2 | yellow | yellow | yellow | yellow | yellow |
| | | green | green | | green |

TABLE 25

| 0.09 g | | | | | |
|---|---|---|---|---|---|
| PSS BB | 10-15% | Ambient | Ambient | 62% RH | 84% RH |
| (light blue) | RH paper | paper | film | paper | paper |
| Day 1 | darker | dark blue | dark blue | dark green | dark green |
| | yellow | | | | |
| Day 2 | darker | dark blue | dark blue | dark green | dark green |
| | yellow | | | | |

TABLE 26

| 0.9 g | | | | | |
|---|---|---|---|---|---|
| PSS BB | 10-15% | Ambient | Ambient | 62% RH | 84% RH |
| (blue) | RH paper | paper | film | paper | paper |
| Day 1 | yellow | blue | green | green | green |
| Day 2 | yellow | blue | green blue | green | green |

### Example 5

An aqueous solution of PSS and brilliant blue was prepared including 0.1 g of aqueous PSS and 0.03 g of brilliant blue dye.

After mixing, 2-3 drops of the solution was applied to three different substrates: Boveda PET film (0.07 mm), PET sheet (3.5 mil/0.0889 mm), and PET film (1.5 mm). The samples were allowed to air dry to create sample humidity indicator systems. The humidity indicator systems were then placed in various controlled humidity environments including 32%, 45%, 62% and 84% relative humidity. After 24 hours in the controlled humidity environment, the colors of the humidity indicator films were assessed and photographs were taken of some of the samples.

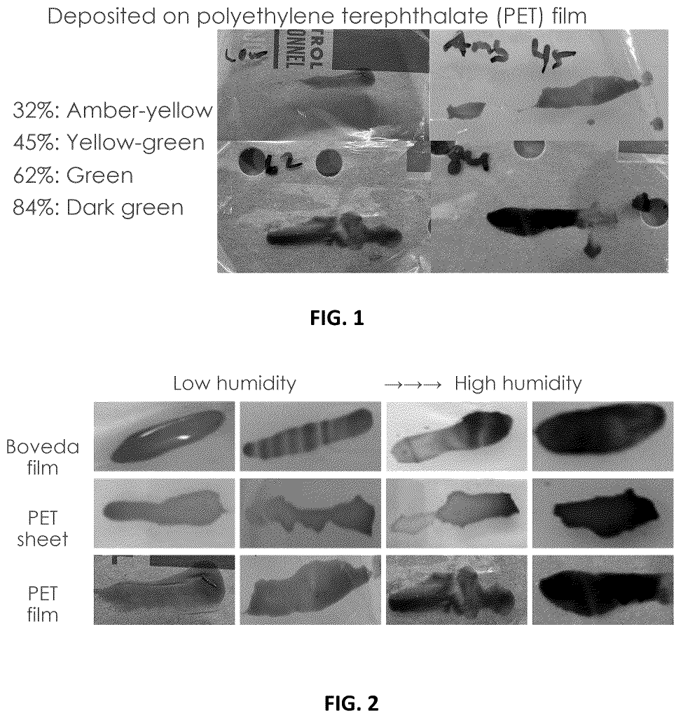

Photographs of the results for the Boveda (polyethylene terephthalate) film are shown in FIG. 1. At 32% relative humidity, the indicator film was amber-yellow. At 45% relative humidity, the indicator film was yellow-green. At 62% relative humidity, the indicator film was green. At 84% relative humidity, the indicator film was dark green.

The sample humidity indicator systems were then removed from their controlled humidity spaces and placed in different controlled humidity spaces with opposite humidity levels for 24 hours. The results are shown in FIG. 2. Each row in FIG. 2 shows the same sample as photographed at each humidity level. The same color spectrum from amber-yellow to dark green was seen for all sample humidity indicator films on all substrates. Furthermore, all sample humidity indicators films changed color in accordance with the humidity in a reversable way.

The process was repeated, with the sample humidity indicator systems being moved back and forth between high and low humidity environments, multiple times, and the color changes of the humidity indicator films remained consistent and true on all substrates.

### Example 6

Different drying methods were assessed. An aqueous humidity indicator solution was prepared as described in Example 5. Two to three drops of solution were applied to each of the following substrates: Boveda films (polyethylene terephthalate); PET sheets; and and PET films. When initially applied, the wet humidity indicator solutions were dark blue-green, reflecting their 100% humidity.

A first set of samples was slowly air dried at ambient temperature and humidity for at least 8 hours. A second set of samples was quickly dried in an oven at approximately 120 degrees F.

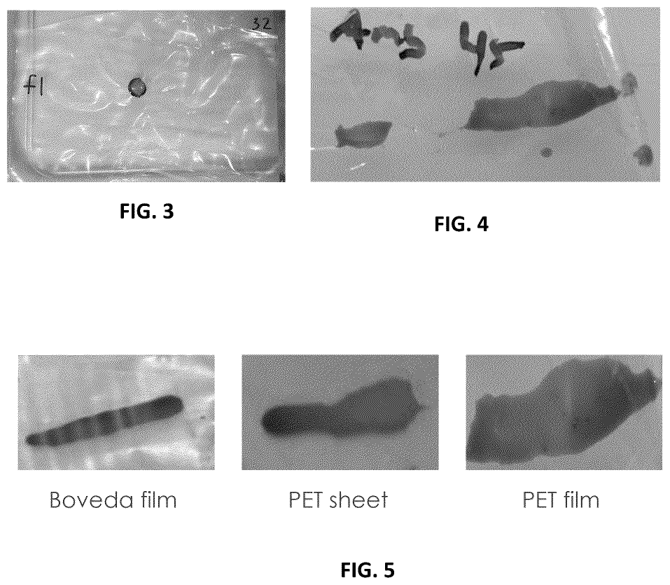

Photographs of the dried samples are shown in FIGS. 3-5. FIGS. 3 and 4 show photographs of the films of dried humidity indicator solution on flexible PET film. The humidity indicator film in FIG. 3 was dried in the oven, while the humidity indicator film in FIG. 4 was air dried. The oven dried sample was less uniform, while the air-dried sample produced a much more uniformly colored film. The oven dried samples were also more prone to cracking. In addition, when used to test humidity, the air-dried samples seemed to change color more quickly than those dried in the oven.

FIG. 5 shows photographs of the samples on all three substrates, after air drying. The humidity indicator solution produced a uniformly colored film with a similar yellow color on all three substrates.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A humidity control indicator solution comprising an aqueous solution of approximately 3-30 wt. % of a polymer and approximately 0.1-1.0 wt % of a dye.

2. The humidity control indicator solution of claim 1, wherein the polymer and the dye are non-toxic.

3. The humidity control indicator solution of claim 2, wherein the polymer is about 5.5 wt % of the solution, and the dye is about 0.5 wt % of the solution.

4. The humidity control indicator solution of claim 1, wherein the polymer is polystyrene sulfonic acid (PPS).

5. The humidity control indicator solution of claim 4, wherein the dye is brilliant blue.

6. The humidity control indicator solution of claim 3, wherein the polymer is polystyrene sulfonic acid (PPS).

7. The humidity control indicator solution of claim 6, wherein the dye is brilliant blue.

8. The humidity control indicator solution of claim 4, wherein the dye is exberry vivid red.

9. The humidity control indicator solution of claim 6, wherein the dye is exberry vivid red.

10. A humidity control indicator comprising:
a substrate;
a humidity indicator film on the substrate, wherein the humidity indicator film comprises a dried solution of an aqueous polymer and a dye.

11. The humidity control indicator of claim 10, wherein the polymer and the dye are non-toxic.

12. The humidity control indicator of claim 11, wherein the polymer is PSS.

13. The humidity control indicator of claim 12, wherein the dye is brilliant blue.

14. The humidity control indicator of claim 13, wherein the dried solution is dried at ambient temperature and humidity.

15. The humidity control indicator of claim 14, wherein the dried solution is dried for at least eight hours.

16. The humidity control indicator of claim 10, wherein the substrate comprises a humidity control device.

17. The humidity control indicator of claim 10, wherein the substrate comprises a sheet.

18. The humidity control indicator of claim 17, the humidity control indicator further comprising an adhesive on a side of the film opposite the humidity indicator film.

19. A humidity control indicator system, comprising:
a humidity control device;
a humidity control indicator, comprising a substrate, and a humidity indicator film on the substrate, the humidity indicator film comprising a dried solution of PPS and brilliant blue,
wherein the humidity control indicator is adhered to the humidity control device.

20. The humidity control indictor system of claim 19, the dried solution further comprising a thickener.
